(19) United States
(12) Patent Application Publication
(10) Pub. No.: US 2026/0249393 A1
(43) Pub. Date: Aug. 27, 2026

(54) MULTI-PIECE NOZZLE FOR A LASER PROCESSING SYSTEM WITH A REPLACEABLE NOZZLE BORE

(71) Applicant: Hypertherm, Inc., Hanover, NH (US)

(72) Inventors: Kenneth J. Woods, New London, NH (US); Marco Celeghin, Noale (IT); Joe Ciambra, Thetford Center, VT (US); James Neval Huff, JR., Braintree, VT (US); Minah Puddy Wheatley, Minneapolis, MN (US); David J. Cook, Bradford, VT (US); Paul Dominic Leonardo, Lebanon, NH (US)

(21) Appl. No.: 19/548,001

(22) Filed: Feb. 24, 2026

Related U.S. Application Data
(60) Provisional application No. 63/762,392, filed on Feb. 24, 2025.

(51) Int. Cl. B23K 26/14

(52) U.S. Cl. CPC B23K 26/1482

(57) ABSTRACT

A nozzle for a laser processing head is provided. The nozzle includes a body comprising a central passage disposed within the body and an engagement feature located on a circumferential interior surface of the central passage. The nozzle also includes a replaceable nozzle bore disposed within the central passage and located proximate the distal end of the body. The nozzle further includes a bore nut disposed within the central passage axially aft of the nozzle bore along the longitudinal axis. The bore nut includes a complementary engagement feature configured to complement and fixedly engage the engagement feature of the body to axially position and retain the nozzle bore within the body.

### CROSS REFERENCE TO RELATED APPLICATION

This application claims the benefit of and priority to U.S. Provisional Patent Application No. 63/762,392 filed on Feb. 24, 2025, which is owned by the assignee of the instant application and is incorporated herein by reference in its entirety.

### TECHNICAL FIELD

The present invention generally relates to a multi-piece nozzle for a laser processing system.

### BACKGROUND

Material processing systems such as laser processing systems, liquid jet processing systems, and plasma arc processing systems are typically used to cut or gouge materials, such as metal sheets. Frequently, laser processing systems are used in precision cutting operations due to the control provided by the laser beam, gas jet, and geometry of the laser nozzle of this type of system. Laser processing systems can generally include a high-power laser, a pressurized gas stream, an optical system, and a computer numerical control (CNC) unit.

In operation, laser processing systems use a pressurized gas stream to blow molten material away from the work area. The flow profile of the gas stream can be determined by the operating pressure and physical characteristics of the nozzle geometry. Traditionally, the gas stream includes air, oxygen, nitrogen, argon, etc. or mixtures of these various gases. The selected gas chemistry and workpiece material are adapted to have significant impact on cutting performance and results. In addition, in typical laser processing systems, the diameter of the laser beam can be approximately the same as the diameter of the nozzle orifice; therefore, to generate satisfiable cutting quality and nozzle life, the operating window (e.g., design space or flexibility for adjusting dimensions) for the beam focus and nozzle size is quite narrow.

The increase in demand for more precision in the desired cuts when using laser processing systems, especially in view of the many extreme conditions that laser nozzles are exposed to during operations (e.g., drastic thermal loads and variations, workpiece collisions, high pressure gas flows, slag and dross exposure, etc.), has led to the development of increasingly complex and intricate laser nozzle designs. Such increased complexity and tolerancing of these laser nozzles drive the improved performance and processing outcomes, but have also increased the manufacturing cost of creating these laser nozzles as well as having increased the cost to the operators when laser nozzles need to be replaced.

Some laser nozzle designers have attempted to reduce the cost associated with laser nozzle wear and tear by designing double nozzles with a replaceable central/inner core. During operation, the portions of a nozzle that are closest to and/or directly exposed to the laser beam (e.g., primary heat load) and primary gas flow are the quickest to degrade/lose life and can lead to a failure of the nozzle. The intent of these multi-piece nozzle designs is that several inner replaceable cores can be used in a single outer nozzle body prior to the outer nozzle body itself being exhausted. This can reduce machining costs as well as material costs with the inner core being consumed at a much higher rate and being defeatured and formed from a significantly reduced diameter bar stock. However, these designs have failed in producing a small enough central/inner core insert, particularly with core inserts formed of expensive materials (e.g., precious metals).

Therefore, there is a need for more optimized multi-piece nozzle designs for laser processing systems.

### SUMMARY

The present invention features a laser nozzle with an outer nozzle body and a replaceable inner core component that comprises a primary conduit of the laser nozzle. For example, the primary conduit can be an integral feature of the inner core component. In some embodiments, the replaceable inner core component includes at least one of an upper nut and a lower nozzle bore. The lower nozzle bore can be plated in a material different from that of the upper nut and can be retained to the outer nozzle body via the upper nut. For example, an internal thread connection can be provided between the upper nut and the outer nozzle body for engagement (e.g., installation and removal) between the outer nozzle body and the inner core component. In some embodiments, the lower nozzle bore includes at least one alignment feature disposed on an outer circumferential surface to facilitate functional alignment with the outer nozzle body and the central longitudinal axis of the laser nozzle.

In one aspect, a nozzle for a laser processing head is provided. The nozzle includes a body defining a central longitudinal axis extending between a proximal end and a distal end. The body includes a retention feature located at the proximal end of the body configured to operably connect the nozzle to a body of the laser processing head, a central passage disposed within the body extending between the proximal end and the distal end along the central longitudinal axis, and an engagement feature located on a circumferential interior surface of the central passage. The nozzle also includes a replaceable nozzle bore disposed within the central passage of the body and located proximate the distal end of the body. The nozzle further includes a bore nut disposed within the central passage axially aft of the nozzle bore along the longitudinal axis. The bore nut includes a complementary engagement feature configured to complement and fixedly engage the engagement feature of the body to axially position and retain the nozzle bore within the body.

In yet another aspect, a replaceable nozzle bore for a nozzle of a laser processing head is provided. The nozzle bore comprises a bore body configured to be non-attachably disposed within a central passage of a body of the nozzle. The bore body defines a longitudinal axis extending between a proximal end and a distal end of the bore body. The nozzle bore also includes an alignment region formed on an external circumferential surface of the bore body. The alignment region is configured to contact and align with a complementary alignment region of the central passage of the nozzle body. The nozzle bore further includes a central conduit disposed within the bore body extending between the proximal end and the distal end. An inner circumferential surface of the central conduit of the nozzle bore is plated with a first metal and a remaining portion of the nozzle bore comprises a second metal. The first metal has a higher reflectivity than the second metal.

In yet another aspect, a bore nut for a nozzle of a laser processing head is provided. The bore nut comprises a bore nut body configured to be disposed within a central passage of a body of the nozzle. The bore nut body defines a longitudinal axis extending between a proximal end and a distal end of the bore nut body. The bore nut also includes an engagement region formed on an external circumferential surface of the bore nut body. The engagement region is configured to operably couple to a complementary engagement region of the central passage of the nozzle body. The bore nut further includes a central conduit disposed within the bore nut body extending between the proximal end and the distal end and a distal end face of the bore nut body configured to axially contact and locate a replaceable nozzle bore in the nozzle body such that the bore nut body is positioned proximally relative to the replaceable nozzle bore within the central passage of the nozzle body.

In yet another aspect, a method of assembling a laser nozzle is provided. The method includes providing a body that defines a central longitudinal axis extending between a proximal end and a distal end of the body. The body includes a central passage extending between the proximal end and the distal end along the central longitudinal axis. The method also includes inserting a nozzle bore into the central passage of the body from the proximal end and disposing a bore nut into the central passage of the body from the proximal end. A distal end face of the bore nut is configured axially contact and complement a proximal end of the nozzle bore to locate the nozzle bore within the body. The method additionally includes engaging the bore nut to the body via respective ones of engagement regions of the bore nut and the central passage of the body to form an engagement interface. The engaging motion is adapted to distally advance the nozzle bore within the central passage along the longitudinal axis. The method further includes radially and axially aligning the nozzle bore with the central passage of the body as the nozzle bore and the bore nut distally advance within the central passage. The aligning forms an alignment interface between an external circumferential surface of the nozzle bore and an internal circumferential surface of the central passage. The alignment interface is located distal to the engagement interface along the longitudinal axis.

Any of the above aspects can include one or more of the following features. In some embodiments, the nozzle bore is formed from a first metal and is plated on at least a portion of a surface with a second metal. For example, an outer circumferential surface of the nozzle bore is not plated.

In some embodiments, the bore nut defines a first portion of a primary passage for conducting a laser beam therethrough and the nozzle bore defines a second portion of the primary passage. A diameter of the first portion of the primary passage of the bore nut is larger than a diameter of the second portion of the primary passage of the nozzle bore. In some embodiments, a proximal end of the nozzle bore is configured to completement and form an abutting contact with a distal end of the bore nut.

In some embodiments, a combination of an axial length of the nozzle bore along the longitudinal and an axial length of the bore nut along the longitudinal axis is less than an axial length of the body along the longitudinal axis. In some embodiments, the nozzle bore is completely disposed within the body. In some embodiments, the bore nut is completely disposed within the body.

In some embodiments, the engagement feature of the body and the complementary engagement feature of the bore nut comprise one or more threads. In some embodiments, the nozzle bore comprises an outer circumferential surface configured to form an alignment interface with an inner circumferential surface on the central passage of the body. In some embodiments, the interface comprises a conical-to-hemispherical or conical-to-conical interface. In some embodiments, the alignment interface is distal to an engagement interface formed between the engagement feature of the body and the complementary engagement feature of the bore nut.

In some embodiments, a distal tip of the body includes a set of one or more castellations configured to contact a workpiece while protecting the nozzle bore. In some embodiments, a distal tip of the nozzle bore is recessed within the central passage of the body.

In some embodiments, to replace the nozzle bore of the nozzle, the bore nut is first disengaged from the body at the engagement interface. The bore nut is then removed followed by removing the nozzle bore from the body via the proximal end of the body. A second nozzle bore is inserted into the body. The second nozzle bore is located within the body by disposing the bore nut into and engaging the bore nut with the central passage of the body.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows a cross-sectional view of an exemplary multi-piece nozzle for a laser processing head, according to some embodiments of the present invention.

FIG. 2 shows a cross-sectional view of another exemplary multi-piece nozzle for a laser processing head, according to some embodiments of the present invention.

FIG. 3 shows a cross-sectional view of another exemplary multi-piece nozzle for a laser processing head, according to some embodiments of the present invention.

FIG. 4 shows a cross-sectional view of yet another exemplary multi-piece laser nozzle for a laser processing head, according to some embodiments of the present invention.

FIG. 5 shows a cross-sectional view of a portion of the exemplary multi-piece laser nozzle of FIG. 4 with a secondary gas flow path therethrough, according to some embodiments of the present invention.

FIG. 6 shows an end view of an exemplary configuration of the distal tip of the multi-piece laser nozzle of FIG. 4, according to some embodiments of the present invention.

FIG. 7 shows an exemplary method for assembling a multi-piece nozzle, such as nozzles of FIGS. 1-6, according to some embodiments of the present invention.

### DETAILED DESCRIPTION

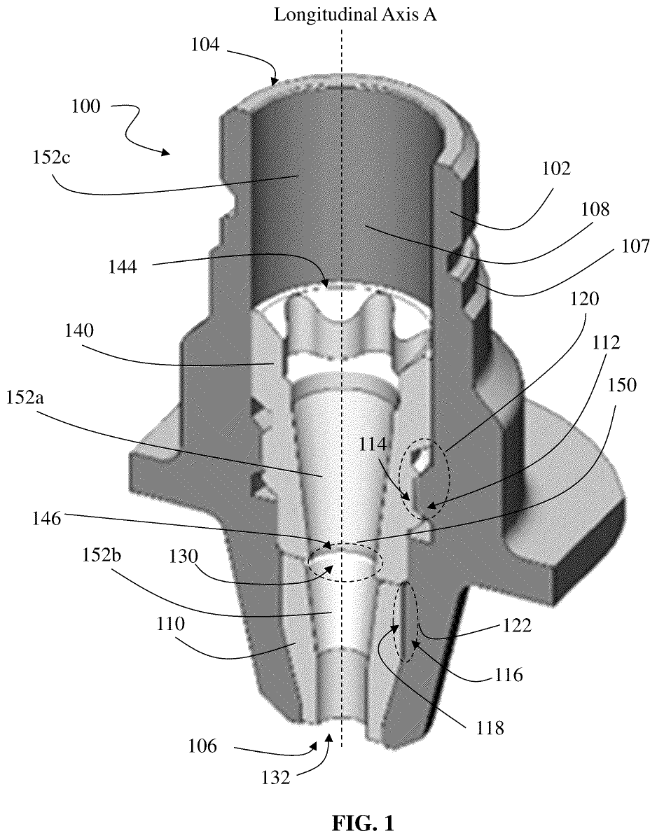

FIG. 1 shows a cross-sectional view of an exemplary multi-piece nozzle 100 for a laser processing head, according to some embodiments of the present invention. As shown, the nozzle 100 generally includes an outer body 102 defining a central longitudinal axis A extending between a proximal end 104 and a distal end 106 of the outer body 102. The distal end 106 is defined as the end that is closest to a workpiece (not shown) during an operation of the laser processing head. The proximal end 104 is disposed opposite of the distal end 106 along central longitudinal axis A. The proximal end 104 can include a retention feature 107, such as a circumferential groove, to operably connect the nozzle 100 to a body of the laser processing head. The outer body 102 also includes a central passage/orifice 108 extending between the proximal end 104 and the distal end 106 along central longitudinal axis A. In some embodiments, the central passage 108 has a diameter of between about 2 cm and about 1 mm, such as between about 1.2 cm and 2.5 mm (e.g., between about 1.2 mm and about 5 mm) at its narrowest inner circumference.

The nozzle 100 additionally includes a replaceable nozzle bore 110 disposed within the central passage 108 of the outer body 102 from the proximal end 104 of the nozzle. The nozzle bore 110 has a body that extends along the central longitudinal axis A between a proximal end 130 and a distal end 132 of the nozzle bore 110. In some embodiments, upon assembly of the nozzle 100, the nozzle bore 110 is completely disposed within the nozzle body 102 and located proximate the distal end 106 of the nozzle body 102.

The nozzle 100 further includes a core nut 140 disposed within the central passage 108 of the outer nozzle body 102 from the proximal end 104 of the nozzle 100. As shown, the core nut 140 comprises a body defining a proximal end 144 and a distal end 146 disposed along central longitudinal axis A. In some embodiments, the distal end 146 of the core nut 140 is shaped to complement and form an abutting contact with the proximal end 130 of the nozzle bore 110 once the core nut 140 is located with the central passage 108 of the nozzle body 102 to axially secure the nozzle bore 110 thereto/therein. The contact between the distal end 146 of the core nut 140 and the proximal end 130 of the nozzle bore 110 is adapted to form an interface 150. In some embodiments, upon assembly of the nozzle 100, the core nut 140 is also completely disposed within the nozzle body 102, such as located axially aft the nozzle bore 110 within the nozzle body 102. In some embodiments, the sum of the axial length of the nozzle bore 110 along longitudinal axis A and the axial length of the bore nut 140 along longitudinal axis A is less than the axial length of the nozzle body 102 along longitudinal axis A.

In some embodiments, once inserted, the core nut 140, in cooperation with the nozzle body 102, axially positions and retains the nozzle bore 110 within the outer nozzle body 102. More specifically, the core nut 140 includes an engagement region located on a circumferential outer surface 114 that is configured to be coupled to a corresponding engagement region located on a circumferential interior surface 112 of the outer nozzle body 102 (e.g., on the central passage 108 of the nozzle body 102) to create an engagement interface 120 therebetween. As an example, the engagement regions 112, 114 can comprise complementary threads and the interface 120 can be formed via a threaded connection. The engagement interface 120 retains the core nut 140 to the nozzle body 102, and since the core nut 140 also abuts the nozzle bore 110 at its distal end 146 via interface 150, the nozzle bore 110 is indirectly retained to the nozzle body 102 by the core nut 140 and the engagement interface 120. In some embodiments, the nozzle bore 110 does not possess any engagement features that directly attach/couple the nozzle bore 110 to the nozzle body 102.

In some embodiments, the engagement between the core nut 140 and the outer nozzle body 102 to achieve the engagement interface 120 also drives the nozzle bore 110 proximally forward/distal into circumferential contact with the outer nozzle body 102 to precisely align the nozzle bore 110 with the outer nozzle body 102. The resulting alignment between the nozzle bore 110 and the outer nozzle body 102 is adapted to form an alignment interface 122. For example, during installation, as the core nut 140 is threaded into the outer nozzle body 102 at the engagement interface 120, the core nut 140 also presses the nozzle bore 110 distally at the contact interface 150 until the nozzle bore 110 is tightly wedged into the central passage 108 of the outer nozzle body 102 such that the nozzle bore 110 is immobilized from further axial advancement, resulting in more precise alignment of the nozzle bore 110 with longitudinal axis A and the outer nozzle body 102.

More specifically, the nozzle bore 110 can align with the outer body 102 via an alignment region located on a circumferential outer surface 118 of the nozzle bore 110 and a complementary alignment region located on a circumferential interior surface 116 of the outer body 102 (e.g., on the central passage 108 of the outer body 102) to form the alignment interface 122. In some embodiments, the outer circumferential surface 118 of the nozzle bore 110 is circumferentially angled, such as between about 10 degrees and about 50 degrees, to contact the complementary angled circumferential interior surface 116 of the outer body 102. The resulting alignment interface 122 can comprise a cone shape/profile on one of the outer body 102 or the nozzle bore 110 and a complementary hemisphere shape/profile on the other of the outer body 102 or the nozzle bore 110, such that a substantially straight line of contact is created at the interface 122. The alignment interface 122 can comprise one of conical-to-hemispherical interface or conical-to-conical interface. For example, as shown in FIG. 1, the alignment interface 122 is shaped as a conical mating datum between a proximal/upper portion of the inner nozzle bore 110 and the outer nozzle body 102. In some embodiments, the alignment region 116 of the outer body 102 serves as an axial stop on the nozzle bore 110 to prevent the nozzle bore 110 from further axial advancement in the distal direction within the central passage 108 of the outer body 102, while the resulting alignment interface 122 serves to axially align the two components 102, 110.

As shown in FIG. 1, the alignment interface 122 can be located axially distal of the engagement interface 120 that is configured to provide means of retention between the nozzle bore 110 and the outer body 102. For the outer body 102, the alignment region 116 can be axially spaced from (e.g., distal to) the engagement region 112. For the nozzle bore 110, the alignment region 118 can be axially spaced from (e.g., distal to) the engagement region 114. In some embodiments, the engagement (e.g., threading) achieved at the engagement interface 120 serves a secondary alignment function in addition to the alignment interface 122.

In some embodiments, the outer nozzle body 102, the bore nut 140 in combination with the nozzle bore 110 define a central primary conduit extending along central longitudinal axis A between the proximal end 104 of the nozzle body 102 and the distal end 132 of the nozzle bore 110. The primary conduit is adapted to conduct a laser beam and/or a gas therethrough for impingement on a workpiece (not shown) during processing. Specifically, the outer nozzle body 102 defines a proximal portion 152c of the primary conduit, the bore nut 140 defines a central portion 152a of the primary conduit, while the nozzle bore 110 defines a distal portion 152b of the primary conduit. The portions 152a-c collectively form the primary conduit, which is referred to herein as “primary conduit 152”. In some embodiments, a diameter of the central primary conduit portion 152a within the bore nut 140 is larger than a diameter of the distal primary conduit portion 152b within the nozzle bore 110.

In some embodiments, the nozzle bore 110, core nut 140 and the outer nozzle body 102 are made from different materials each selected from brass, copper, silver, etc., to enhance robustness and functionality. In some embodiments, plating (e.g., silver plating, gold plating, layered dielectric coatings such as high reflection coatings on mirrors, etc.) is applied to one or more functional surfaces of one or both of the nozzle bore 110, the core nut 140, and/or the nozzle body 102. In some embodiments, at least one of the nozzle bore 110 or the core nut 140 is not field serviceable, instead is integrally connected to (e.g., crimped into) the outer nozzle body 102. As an example, the nozzle bore 110 can comprise silver (e.g., comprising greater than 80% silver) and is permanently disposed within the outer nozzle body 102 comprising copper (e.g., comprising less than 80% silver).

In some embodiments, the nozzle bore 110 is field serviceable and easily replaceable. In some embodiments, the nozzle bore 110 is formed from a base/first metal, such as copper, and is plated and/or coated on at least a portion of its surface with a second metal, such as silver. In some embodiments, the second metal used for the plating and/or coating has a higher reflectivity than the first metal. As an example, an outer circumferential surface of the nozzle bore 110 can be not plated and/or coated, while an inner circumferential surface that forms the distal portion 152b of the primary conduit 152 is plated and/or coated with the second material. Alternatively, substantially all of the surfaces of the nozzle bore 110 can be plated and/or coated with the second material. Alternatively, the nozzle bore 110 is formed with the second material without any plating. In some embodiments, the core nut 140 is formed from an electrically conductive material without plating or coating, such as copper or brass. In some embodiments, the core nut 140 is formed from the first material of the nozzle bore 110. Alternatively, the core nut 140 is formed from a third material that is different from the first and second material of the nozzle bore 110.

In some embodiments, the distal surface on the distal end 132 of the nozzle bore 110 is axially recessed relative a distal surface on the distal end 106 of the outer body 102 such that the nozzle bore 110 at the distal end 132 is distant from and/or recessed within the outer nozzle body 102 at its distal end 106. This design allows the distal surface of the outer nozzle body 102 to endure the most damage from any workpiece scrapes generated during torch operation, thereby reducing damage to the primary conduit 152 from which the laser beam is conducted to the workpiece. In some embodiments, the outer nozzle body 102 includes a set of collision features (not shown), such as castellations, at its distal surface that are configured to contact a workpiece or extend in the event of an accidental collision, thereby shielding the primary conduit 152 for the purposes of collision prevention. For example, four castellations with a height of less than about 0.5 mm in the form of bumps can be disposed at the distal surface of the outer body 102 to shoulder the impact of a collision. In some embodiments, the castellations are configured as whiskers that are adapted to bend/break to allow a vision system to detect the severity of a collision.

In some embodiments, a set of circumferentially arranged and axially canted fluid flow passages (not shown) are disposed in the outer body 102 about the longitudinal axis A. For example, these fluid flow passages can conduct water or gas therethrough. During operation of the laser nozzle 100, an assist gas can be conducted through the primary conduit 152 while water can be conducted through these fluid flow passages in the outer body 102 completely isolated from the assist gas such that no complex sealing within the laser nozzle 100 is required.

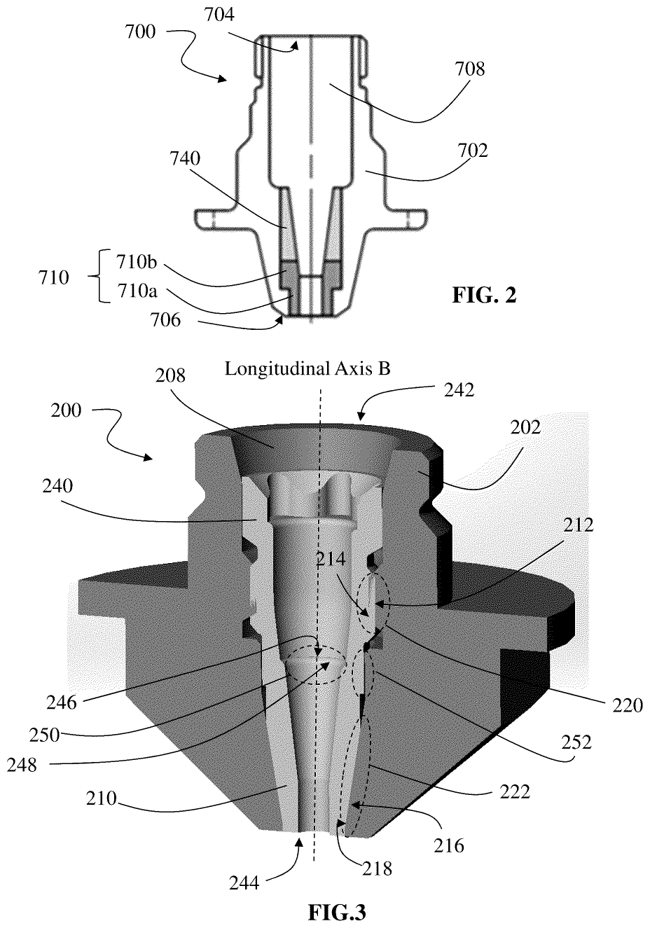

FIG. 2 shows a cross-sectional view of another exemplary multi-piece nozzle 700 for a laser processing head, according to some embodiments of the present invention. As shown, the multipiece nozzle 700 includes a nozzle bore 710 and a bore nut 740 disposed within a central passage 708 of an outer nozzle body 702, similar in configuration to the multi-piece nozzle 100 of FIG. 1. The central passage 708 of the outer nozzle body 702 is configured to extend longitudinally from the proximal end 704 to the distal end 706 of the outer nozzle body 702. In some embodiments, a cross-sectional opening of the central passage 708 of the outer nozzle body 702 proximate the distal end 706 of the nozzle body 702 is narrower than a cross-sectional opening proximate the proximal end 704 of the nozzle body 702.

To assemble the multipiece nozzle 700, the nozzle bore 710, followed by the bore nut 740, are inserted into the central passage 708 from the proximal end 704 of the outer nozzle body 702. More specifically, during assembly, the nozzle bore 710 can be first inserted into the central passage 708 of the outer nozzle body 702 via its proximal end 704. In this case, the nozzle bore 710 can have a cross-sectional width larger than the narrowest portion of the central passage 708 of the outer nozzle body 702 (e.g., proximate the distal end 706 of the outer nozzle body 702). In the embodiment shown in FIG. 2, the nozzle bore 710 includes a distal portion 710a that extends into the narrowest portion of the central passage 708 and a proximal portion 710b that is wider than the narrowest portion of the central passage 708. The proximal portion 710b thus functions as an axial stop for the nozzle bore 710 within the central passage 708 of the outer nozzle body 702. For example, this proximal portion 710b can include a step feature shaped to complement a step feature formed on an interior surface of the central passage 708 of the outer nozzle body 702, which serves to substantially axially align and locate the nozzle bore 710 relative to the central passage 708. In some embodiments, the distal portion 710a of the nozzle bore 710 has a narrow outer circumference, which is able to extend within the distal tip 706 of the central passage 708 of the outer nozzle body 702 (i.e., into the narrowest section of the central passage 708) without physically and/or forcibly contacting (e.g., physically touching but applying little to no force across the distinct components) the interior surface of the central passage 708 at this distal tip 706.

Bore nut 740 is then inserted into the central passage 708 of the outer nozzle body 702 via the proximal end 704, following the insertion of nozzle bore 710. In some embodiments, bore nut 740 includes one or more distal features shaped to contact/abut nozzle bore 710 and one or more outer circumferential engagement features to engage complementary features of the central passage 708 of the outer nozzle body 702 to retain the nozzle bore 710 within the outer nozzle body 702. For example, the interface formed between the core nut 740 and the nozzle bore 710 can be substantially the same as the interface 150 of FIG. 1, and the engagement interface formed between the bore nut 740 and the central passage 708 can be substantially the same as the engagement interface 120 of FIG. 1. In some embodiments, either or both of bore nut 740 and/or nozzle bore 710 are plated by a metal different than the majority of the component composition as discussed herein. For example, material compositions, including plating, of the bore nut 740 and/or the nozzle bore 710 can be substantially the same as the corresponding components 140, 110 described above with reference to the multi-piece nozzle 100 of FIG. 1.

FIG. 3 shows a cross-sectional view of another exemplary multi-piece nozzle 200 for a laser processing head, according to some embodiments of the present invention. As shown, the multi-piece nozzle 200 includes an inner nozzle bore 210 retained to an outer nozzle body 202 via a core nut 240 disposed within a central passage 208 of the outer nozzle body 202 from the proximal end 242 of the nozzle 200. In some embodiments, the outer nozzle body 202 is similar to the outer body 102, the core nut 240 is similar to the core nut 140, and the nozzle bore 210 is similar to the nozzle bore 110 of nozzle 100 of FIG. 1.

In some embodiments, the nozzle bore 210 includes an alignment region 218 configured to align with a corresponding interior surface 216 of the outer nozzle body 202 to create an alignment interface 222. In comparison to the alignment interface 122 of FIG. 1, the alignment interface 222 of FIG. 3 comprises the lower/distal portion of the nozzle bore 210 proximate the distal end 244 of the nozzle 200, whereas the alignment interface 122 of FIG. 1 is more spaced from the distal end 106 of the nozzle 100 and comprises the upper/proximal portion of the nozzle bore 110. In some embodiments, the alignment interface 222 is a conical-to-hemispherical or conical-to-conical interface.

In some embodiments, the core nut 240 includes an engagement region 214 (e.g., substantially the same as the engagement region 114 of nozzle 100) configured to engage a corresponding interior surface 212 of the outer nozzle body 202 to create an engagement interface 220 (e.g., substantially the same as the engagement interface 120 of nozzle 100) that retains the nozzle bore 210 and core nut 240 to the nozzle body 202. Similar to engagement region 114 of nozzle 100, engagement region 214 can comprise threads that complement threads on the interior surface 212 of the outer nozzle body 202 to engage the core nut 240 and the outer nozzle body 202 to each other. In some embodiments, the distal end 246 of the core nut 240 includes an axial feature, such as an axial indent shown in FIG. 3, configured to complement and receive the proximal end 248 of the nozzle bore 210 to axially secure the nozzle bore 210 thereto and in turn to the outer nozzle body 202 via the engagement interface 220. In some embodiments, the nozzle bore 210 does not maintain any physical contact with the nozzle body 202 outside of its alignment region 218. In some embodiments, the nozzle bore 210 does not possess any engagement features that directly attach/couple the nozzle bore 210 to the nozzle body 202.

In some embodiments, the resulting interface 250 between the axial indent 246 of the core nut 240 and the proximal end 248 of the nozzle bore 210 is further configured to drive the nozzle bore 210 proximally forward/distal into circumferential contact with the outer nozzle body 202 to precisely align the nozzle bore 210 with the outer nozzle body 210 at the alignment interface 222. More specifically, during installation, as the core nut 240 is threaded into the outer nozzle body 202 at the engagement interface 220, the core nut 240 also presses the nozzle bore 210 distally until the nozzle bore 210 is tightly wedged into the central passage 208 of the outer nozzle body 202 such that the nozzle bore 210 is immobilized from further axial advancement, resulting in more precise alignment of the nozzle bore 210 with the longitudinal axis B and the outer nozzle body 202.

In some embodiments, in addition to the alignment interface 222 formed at the distal end 244 of the nozzle 200, another/secondary cylindrical alignment interface 252 between the core nut 240 and the outer nozzle body 202 can be formed proximate the axial interface 250 between the core nut 240 and the nozzle bore 210. As shown, the secondary cylindrical alignment interface 252 can be formed between an outer circumferential surface of the core nut 240 adjacent to the axial interface 250 and a corresponding inner circumferential surface of the outer body 202.

With reference to the multi-piece laser nozzles 100, 200 of both FIGS. 1 and 3, each nozzle can be assembled at a manufacturing facility with the nozzle bore 110 or 210 first inserted into the central passage 108 or 208 of the outer nozzle body 102 or 202 from the proximal end 104 or 242 of the nozzle 100 or 200. The core nut 140 or 240 can be subsequently disposed into the central passage 108 or 208 from the same proximal end 104 or 242 and affixed, such as crimped or threaded, to the central passage 108 or 208 to form the engagement interface 120 or 220. In some embodiments, the multi-piece laser nozzle 100 or 200 is formed via one of metal injection molding, sintering or otherwise via a lower cost approach. In some embodiments, the assembly or insertion of components relative to each other in each of nozzle 100 or 200 includes a ferrule type of arrangement that crimps one component onto another. Using nozzle 200 as an example, the core nut 240 can be crimped onto the nozzle bore 210 during assembly to form the axial interface 250 (after the nozzle bore 210 is first disposed within the nozzle body 202), such that the core nut 240 drives the nozzle bore 210 distally during the subsequent engagement (e.g., threading) process to affix the core nut 240 (and therefore the nozzle bore 210) to the outer body 202 at the engagement interface 220. In some embodiments, during disassembly of each of nozzle 100 or 200, once unthreaded at the engagement interface 120 or 220, the core nut 140 or 240 can then be disengaged (e.g., uncrimped) from the nozzle bore 110 or 210 at the axial interface 150 or 250 such that at least one of the core nut 140 or 240 or the nozzle bore 110 or 210 is replaceable/reusable.

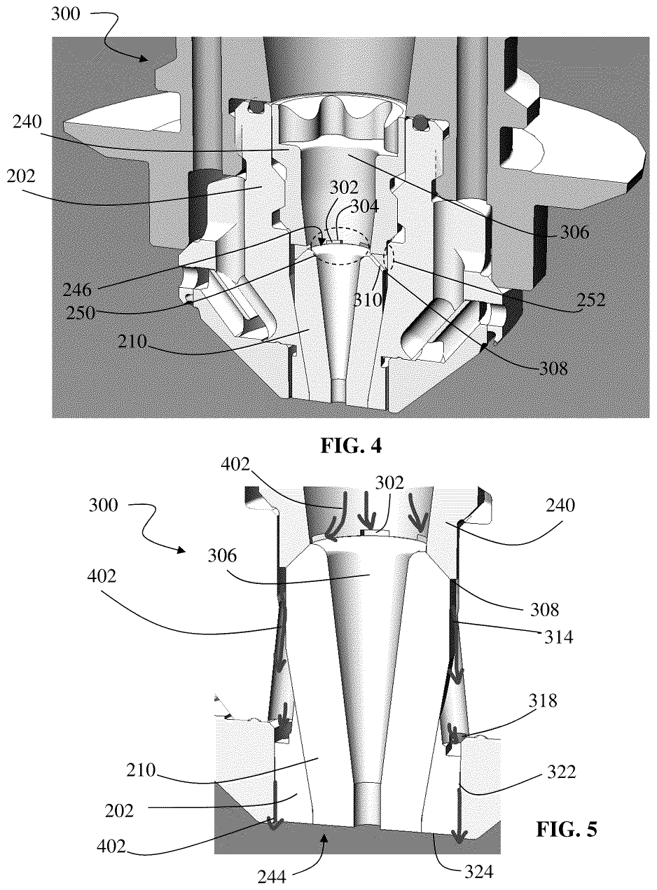

FIG. 4 shows a cross-sectional view of yet another exemplary multi-piece laser nozzle 300 for a laser processing head, according to some embodiments of the present invention. FIG. 5 shows a cross-sectional view of a portion of the exemplary multi-piece laser nozzle 300 of FIG. 4 with a secondary gas flow path therethrough, according to some embodiments of the present invention. The laser nozzle 300 of FIGS. 4 and 5 is similar in configuration to the laser nozzle 200 of FIG. 3, with like components labeled the same.

In comparison to the laser nozzle 200 of FIG. 3, the laser nozzle 300 can additionally include a set of secondary flow passages 302 formed proximate the distal tip 246 of the core nut 240 to permit and develop secondary flow separation. More specifically, about the axial interface 250 between the core nut 240 and the nozzle bore 210, the set of flow passages 302 can be cooperatively formed by complementary surfaces of the two components 240, 210. In some embodiments, each of the secondary flow passages 302 comprises a slot 304 disposed into the distal end 246 of the core nut 240 (and/or a proximal end of the nozzle bore 210). The set of slots 304 can be circumferentially spaced about the alignment interface 252, such that when the core nut 240 is installed and secured to the nozzle bore 210 in position for operation, the contact between the two components 240, 210 defines the slots 304 to form the circumferential set of secondary gas flow passages 302 therebetween. As shown in the embodiments of FIGS. 4 and 5, the slots 304 formed in the core nut 240 are evenly spaced around a circumference of the core nut 240 at the distal tip 246 to produce axially symmetric gas flows therethrough. There can be six such slots 304. In other embodiments, there can be as few as three slots 304 formed in the core nut 240. In other embodiments, there are four or more slots formed in the inner core component (e.g., 5, 12, 18, 24, 48, etc.).

As shown in FIG. 5, the secondary gas flow passages 302 are configured to receive a portion of the primary gas flow from the central conduit 306 extending axially through the core nut 240 and the nozzle bore 210 and redirect the gas flow radially outward and axially distal/forward such that the gas flow is conducted into an annulus 308 formed between the nozzle bore 210 and the outer nozzle body 202. As shown in FIG. 5, the proximal end of the annulus 308 is defined in part by the secondary gas flow passages 302 and the core nut 240. The distal end of the annulus 308 forms an interface with a second set of secondary gas flow passages 314 that are defined by a set of slots formed on an interior surface of the outer nozzle body 202 (e.g., on the central passage 208 of the nozzle body 202) and an exterior surface of the nozzle bore 210. This second set of secondary gas flow passages 314 is configured to direct the secondary gas flow from the annulus 308 to travel axially forward/distal toward the distal tip 244 of the laser nozzle 300. This secondary gas flow profile can be tailored (e.g., optimized, conditioned, etc.) for the particular assist gas type and/or pressure range selected for the cutting operation by the nozzle 300. For example, in an oxygen cutting operation, the secondary gas flow is adapted to be low to support the cut performance as the gas flow provides a circumferential shielding flow of gas about the central conduit 306 of the inner nozzle bore 210 at the distal tip 244, as shown in FIG. 5.

FIG. 5 illustrates an exemplary flow path for the secondary gas flow 402 about and through distal tip 244 of the laser nozzle 300 of FIG. 4. As shown, the secondary gas flow 402 is adapted to flow from a primary gas flow (not shown) conducted through the central conduit 306 of the core nut 240. The secondary gas flow 402 then approaches the interface 250 between the core nut 240 and the nozzle bore 210 as the nozzle bore 210 begins to converge about the central longitudinal axis. This secondary gas flow 402 passes through the first set of secondary gas flow passages 302 to enter the annulus 308 defined between the outer body 202 and the inner nozzle bore 210 before entering the second set of secondary gas flow passages 314 that are defined between the nozzle bore 210 and the outer body 202. In some embodiments, as the secondary gas flow 402 travels axially forward/distal through the second set of secondary gas flow passages 314, it encounters a second annulus 318 defined by the outer body 202 and the nozzle bore 210. This second annulus 318 is configured to allow the secondary gas flow 402 to accumulate (e.g., even out flow distribution) and flow about the distal tip 244 of the nozzle 300 and proximate the central conduit 306 of the inner nozzle bore 210 prior to entering a tertiary set of secondary gas flow passages 322, which are configured to direct the secondary gas flow 402 axially forward/distal to exit from a distal end face 324 of the laser nozzle 300 in a supportive circumferential arrangement around the primary gas flow and laser beam (in the central conduit 306) during processing. In this configuration, the secondary gas flow 402 and the primary gas flow through the central conduit 306 are fluidly isolated from each other in the lower portion of the nozzle 300, i.e., in the region of the nozzle bore 210.

As explained above, the various sets of secondary gas flow passages 302, 314, 322 can be formed via slots in the core nut 240, inner nozzle bore 210, and/or outer nozzle body 202. In general, as well understood in the art, these secondary gas flow passages can be formed via any combinations of complementary slots, annulus, and other passage formation techniques associated with the laser nozzle components. For example, in some embodiments, slots may be formed in one or more of the core nut 240, the inner nozzle bore 210, or the outer nozzle body 202 in a complementary manner such that upon assembly one or more sets of axially oriented secondary gas flow passages are created between the mating surfaces of the components. In some embodiments, portions of the secondary gas flow passages and/or annuluses may be drilled through and/or entirely formed in a single component. In some embodiments, slots and/or secondary gas passages are substantially larger in comparison to the primary central conduit 306 in terms of cross-sectional area to support higher pressures and flow rates for air, mixed gas, and nitrogen cutting. In some embodiments, different combinations of core nut 240, inner nozzle bore 210, and outer nozzle body 202 may be selected and combined in the field to tune nozzle 300 for specific processes (e.g., where larger or smaller secondary flows are desired).

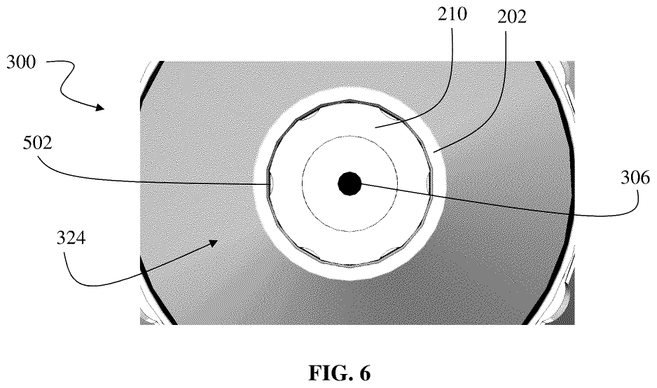

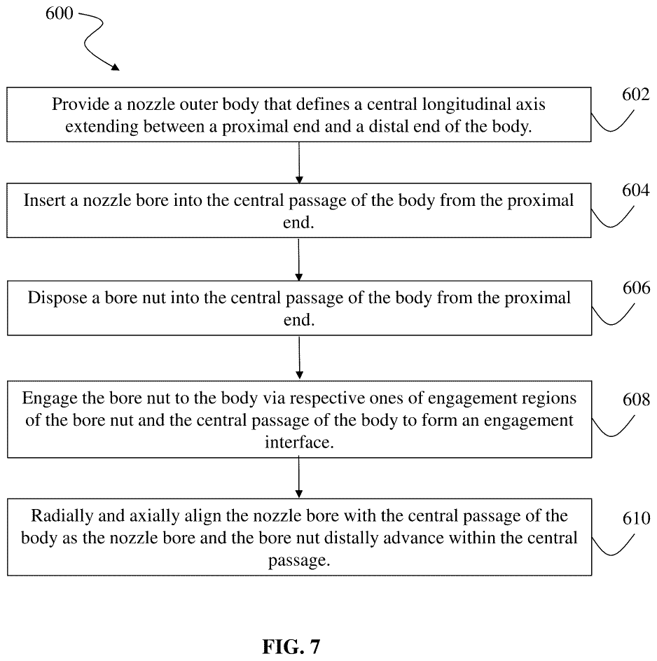

FIG. 6 shows an end view of an exemplary configuration of the distal tip 244 of the multi-piece laser nozzle 300 of FIG. 4, according to some embodiments of the present invention. As shown, the distal end face 324 at the distal tip 244 of the nozzle 300 includes six outlets 502 corresponding to respective ones of the tertiary set of six secondary flow passages 322 defined between the outer nozzle body 202 and the inner nozzle bore 210. These outlets 502 can be evenly spaced in a circumferential manner about the central conduit 306 of the laser nozzle 300 on an outer circumference of the nozzle bore 210 to uniformly distribute the secondary flow about the central conduit 306 that conducts a laser beam therethrough during operation. In addition, these outlets 502 can comprise slots that are partially arcuate in shape (e.g., forming a partial lunar shape when combined with surfaces of the outer nozzle body 202). Even though FIG. 6 illustrates six outlets 502 for the secondary flow having semi-arcuate shapes, in other embodiments more or less outlets can be incorporated into the multi-piece nozzle 300 with varying cross-sectional areas and shapes to promote isotropic behavior proximate the laser beam through the central conduit 306. As well understood by a person of ordinary skill in the art, the passages for conducting various gas/fluid flows described above with reference to the multi-piece nozzle 300 FIGS. 4-6 can be easily incorporated and adapted into the multi-piece nozzle 100 of FIG. 1 or the multi-piece nozzle 200 of FIG. 3.

FIG. 7 shows an exemplary method 600 for assembling a multi-piece nozzle, such as nozzle 100 of FIG. 1, nozzle 200 of FIG. 3 or nozzle 300 of FIGS. 4-6, according to some embodiments of the present invention. The method 600 starts at step 602 by providing a nozzle body, such as nozzle body 102 of nozzle 100 or nozzle body 202 of nozzle 200 or 300. At step 604, a nozzle bore, such as bore 110 of nozzle 100 or bore 210 of nozzle 200 or 300, is inserted into the central passage of the nozzle body from the proximal end of the nozzle body.

At step 606, the core nut 140 or 240 is disposed into the central passage 108 or 208 of the outer nozzle body 102 or 202 from the proximal end of the nozzle body 102 or 202. The core nut 140 or 240 is adapted to be positioned proximally to the nozzle bore 110 or 210 that is already in the central passage 108 or 208 such that the distal end face of the bore nut 140 or 240 is configured to axially contact and complement the proximal end of the nozzle bore 110 or 210 to secure the nozzle bore within the nozzle body 102 or 202.

At step 608, the core nut 140 or 240 is engaged (e.g., threaded or crimped) with the corresponding engagement region on the central passage 108 or 208 of the nozzle body 102 or 202 to form the engagement interface 120 or 220. The engagement motion (e.g., a threading motion) is adapted to exert a downward, distally-biasing force on the nozzle bore 110 or 210 to distally advance the nozzle bore 110 or 210 within the central passage 108 or 208 of the nozzle body 102 or 202 along the longitudinal axis.

At step 610, as the nozzle bore 110 or 210 advances distally in the central passage 108 or 208 of the outer body 102 or 202, the nozzle bore 110 or 210 is adapted to radially and axially align with the central passage of the outer body 102 or 202. Such alignment creates an alignment interface 122 for nozzle 100 or alignment interface 222 for nozzle 200 or 300 between an external circumferential surface of the nozzle bore 110 or 210 and an internal circumferential surface of the central passage 108 or 208 of the outer body 102 or 202. The resulting alignment interface 122 or 222 is distal relative to the engagement interface 120 or 220 along the longitudinal axis.

For nozzle 200 of FIG. 3 or nozzle 300 of FIGS. 4-6, a secondary alignment interface 252 can be formed between an outer surface of the core nut 240 and a corresponding surface of the central passage 208 of the outer nozzle body 202. In these configurations, the secondary alignment interface 252 is distal to the engagement interface 220, and the primary alignment interface 222 is distal to the secondary alignment interface 252. In alternative embodiments, a secondary alignment interface can be created proximally to the engagement interface 252.

For each of the laser nozzles 100, 200 or 300, an operator can easily replace an existing nozzle bore 110 or 210 with a new nozzle bore by first disengaging the core nut 140 or 240 from the outer body 102 or 202 at the engagement interface 120 or 220, followed by removing the nozzle bore 110 or 210 from the central passage 108 or 208 of the outer body 102 or 202 via its proximal end, then inserting the second/new nozzle bore into the outer body 102 or 202 via the proximal end. The same core nut 140 or 240 (or a new/different core nut) can then be inserted into the body 102 or 202 to secure the new nozzle bore in place.

As discussed herein, embodiments of the invention provide low-cost laser nozzles, where each laser nozzle has a replaceable inner bore (e.g., bore 110 of nozzle 100 or bore 210 of nozzle 200 or 300) that has distal alignment features/locating datum (e.g., alignment region 118 of nozzle 100 or alignment region 218 of nozzle 200 or 300) to improve functional alignment. In addition, embodiments of the invention combine manufacturing techniques and tolerances across multiple nozzle components to create a robust and cost-efficient laser nozzle that meets specification and performs optimized laser processes with longer life and/or replaceable components. For example, traditionally a laser nozzle is machined instead of forged because of the tolerance requirements, small sizes of the orifice, and low roughness on the inner bore; in contrast, the multi-piece nozzles of the present invention allows different techniques for forming different pieces/components of a nozzle, such as allowing the outer bodies to be forged and the inner bores to be cold formed, both of which are low cost manufacturing methods that meet functional requirements when combined. Furthermore, for each laser nozzle, the replaceable inner bore (e.g., bore 110 or 210) can be formed with different material properties (e.g., silver, gold, chromium, etc.) than the material properties (e.g., copper) of the outer nozzle body of the laser nozzle (e.g., nozzle body 102 of nozzle 100 or nozzle body 202 of nozzle 200 or 300). In some embodiments, a highly reflective plating is formed on the inner nozzle bore. Generally, selective coating of certain nozzle components or on certain surfaces of a nozzle component simplifies the coating process and reduces cost by using high-cost metal on only critical bore features. Overall, the present invention offers reduction in system operating cost (e.g., nozzle consumption) with design complexities and bar stock diameter being driven to the nozzle body that can operate with several nozzle bores before needing replacement.

It should be understood that various aspects and embodiments of the invention can be combined in various ways. Based on the teachings of this specification, a person of ordinary skill in the art can readily determine how to combine these various embodiments. Modifications may also occur to those skilled in the art upon reading the specification.

What is claimed is:

1. A nozzle for a laser processing head, the nozzle comprising:
a body defining a central longitudinal axis extending between a proximal end and a distal end, the body including:
a retention feature located at the proximal end of the body configured to operably connect the nozzle to a body of the laser processing head;
a central passage disposed within the body extending between the proximal end and the distal end along the central longitudinal axis; and
an engagement feature located on a circumferential interior surface of the central passage;
a replaceable nozzle bore disposed within the central passage of the body and located proximate the distal end of the body; and
a bore nut disposed within the central passage axially aft of the nozzle bore along the longitudinal axis, the bore nut including a complementary engagement feature configured to complement and fixedly engage the engagement feature of the body to axially position and retain the nozzle bore within the body.

2. The nozzle of claim 1, wherein the nozzle bore is formed from a first metal and is plated on at least a portion of a surface with a second metal.

3. The nozzle of claim 2, wherein an outer circumferential surface of the nozzle bore is not plated.

4. The nozzle of claim 1, wherein the bore nut defines a first portion of a primary passage for conducting a laser beam therethrough and the nozzle bore defines a second portion of the primary passage, a diameter of the first portion of the primary passage of the bore nut is larger than a diameter of the second portion of the primary passage of the nozzle bore.

5. The nozzle of claim 1, wherein a proximal end of the nozzle bore is configured to completement and form an abutting contact with a distal end of the bore nut.

6. The nozzle of claim 1, wherein the nozzle bore is completely disposed within the body.

7. The nozzle of claim 1, wherein the bore nut is completely disposed within the body.

8. The nozzle of claim 1, wherein a combination of an axial length of the nozzle bore along the longitudinal and an axial length of the bore nut along the longitudinal axis is less than an axial length of the body along the longitudinal axis.

9. The nozzle of claim 1, the engagement feature of the body and the complementary engagement feature of the bore nut comprise one or more threads.

10. The nozzle of claim 1, wherein the nozzle bore comprises an outer circumferential surface configured to form an alignment interface with an inner circumferential surface on the central passage of the body.

11. The nozzle of claim 10, wherein the interface comprises a conical-to-hemispherical or conical-to-conical interface.

12. The nozzle of claim 10, wherein the alignment interface is distal to an engagement interface formed between the engagement feature of the body and the complementary engagement feature of the bore nut.

13. The nozzle of claim 1, wherein a distal tip of the body includes a set of one or more castellations configured to contact a workpiece while protecting the nozzle bore.

14. The nozzle of claim 1, wherein a distal tip of the nozzle bore is recessed within the central passage of the body.

15. A replaceable nozzle bore for a nozzle of a laser processing head, the nozzle bore comprising:
a bore body configured to be non-attachably disposed within a central passage of a body of the nozzle, the bore body defining a longitudinal axis extending between a proximal end and a distal end of the bore body;
an alignment region formed on an external circumferential surface of the bore body, the alignment region configured to contact and align with a complementary alignment region of the central passage of the nozzle body; and
a central conduit disposed within the bore body extending between the proximal end and the distal end, wherein an inner circumferential surface of the central conduit of the nozzle bore is plated with a first metal and a remaining portion of the nozzle bore comprises a second metal, the first metal having a higher reflectivity than the second metal.

16. A bore nut for a nozzle of a laser processing head, the bore nut comprising:
a bore nut body configured to be disposed within a central passage of a body of the nozzle, the bore nut body defining a longitudinal axis extending between a proximal end and a distal end of the bore nut body;
an engagement region formed on an external circumferential surface of the bore nut body, the engagement region configured to operably couple to a complementary engagement region of the central passage of the nozzle body;
a central conduit disposed within the bore nut body extending between the proximal end and the distal end; and
a distal end face of the bore nut body configured to axially contact and locate a replaceable nozzle bore in the nozzle body such that the bore nut body is positioned proximally relative to the replaceable nozzle bore within the central passage of the nozzle body.

17. A method of assembling a laser nozzle, the method comprising:
providing a body that defines a central longitudinal axis extending between a proximal end and a distal end of the body, the body comprising a central passage extending between the proximal end and the distal end along the central longitudinal axis;
inserting a nozzle bore into the central passage of the body from the proximal end;
disposing a bore nut into the central passage of the body from the proximal end, wherein a distal end face of the bore nut is configured axially contact and complement a proximal end of the nozzle bore to locate the nozzle bore within the body;
engaging the bore nut to the body via respective ones of engagement regions of the bore nut and the central passage of the body to form an engagement interface, the engaging adapted to distally advance the nozzle bore within the central passage along the longitudinal axis; and
radially and axially aligning the nozzle bore with the central passage of the body as the nozzle bore and the bore nut distally advance within the central passage, the aligning forming an alignment interface between an external circumferential surface of the nozzle bore and an internal circumferential surface of the central passage, wherein the alignment interface is located distal to the engagement interface along the longitudinal axis.

18. The method of claim 17, further comprising:
disengaging the bore nut from the body at the engagement interface;
removing the bore nut followed by removing the nozzle bore from the body via the proximal end of the body;
inserting a second nozzle bore into the body; and
locating the second nozzle bore within the body by disposing the bore nut into and engaging the bore nut with central passage of the body.

19. The method of claim 17, wherein engaging the bore nut to the body comprises threading the bore nut to the central passage of the body via complementary threads disposed on the bore nut and in the central passage.

20. The method of claim 17, wherein the nozzle bore is formed from a first metal and plated on at least a portion of a surface with a second metal.
